(19) United States
(12) Patent Application Publication
(10) Pub. No.: US 2025/0254260 A1
(43) Pub. Date: Aug. 7, 2025

(54) IMAGE PROCESSING APPARATUS AND CONTROL METHOD

(71) Applicant: CANON KABUSHIKI KAISHA, Tokyo (JP)

(72) Inventor: MIHO WATANABE, Tokyo (JP)

(21) Appl. No.: 19/040,766

(22) Filed: Jan. 29, 2025

(30) Foreign Application Priority Data
Feb. 2, 2024 (JP) 2024-014588

(51) Int. Cl. H04N 1/32; H04N 1/00

(52) U.S. Cl. CPC H04N 1/32144; H04N 1/00244; H04N 1/0048; H04N 1/00482; H04N 1/00206; H04N 1/00209; H04N 2201/0094; H04N 2201/3245

(57) ABSTRACT

An image processing apparatus includes a generation unit configured to generate original document data by reading an original document, a transmission unit configured to transmit the original document data generated by the generation unit, a first reception unit configured to receive an operation for providing an instruction to transmit the original document data by the transmission unit, a second reception unit configured to receive an operation for enabling a trace-of-correction setting being a setting to include, in the original document data generated by the generation unit, a trace of correction indicating that the original document has been corrected, and a first display unit configured to display a predetermined screen in a case where the first reception unit receives transmission of the original document data and the second reception unit receives the operation for enabling the trace-of-correction setting.

### BACKGROUND

### Field of the Disclosure

The present disclosure relates to an image processing apparatus and a control method.

### Description of the Related Art

Devices that generate original document data, such as an electronic document, by optically scanning an original document, such as a paper document, include a single-function reading device (scanner device) and an image reading device (scanner, etc.) installed in a copier. In recent years, a mobile terminal and the like have also become usable as document scanners. (Hereinafter, these devices will be collectively referred to as “reading devices”).

On the other hand, while only paper documents, such as tax-related ledger sheets, used to be accepted as “authentic original documents”, in recent years, due to changes in a legal system accompanying advances in an electronic documentation technique, electronic documents have also become acceptable as the authentic original documents by satisfying predetermined conditions. One of the conditions for an electronic document to be accepted as the authentic original document is that, when an original document including a trace indicating that the original document has been corrected (e.g., a trace of a correction fluid or the like) (hereinafter, referred to as a trace of correction) is converted into an electronic document, information regarding the trace of correction is not to be lost (i.e., its visibility is to be maintained). In view of the foregoing, Japanese Patent Application Laid-Open No. 2023-112514 discusses a method of automatically executing a job with a setting for leaving a trace of correction in order to leave a trace of correction.

Nevertheless, in Japanese Patent Application Laid-Open No. 2023-112514, since a scan is executed with a setting value automatically changed to a setting value for leaving a trace of correction after a user performs a scan processing execution operation, the user is sometimes unable to recognize a setting value with which the scan has been executed.

### SUMMARY

Embodiments of the present disclosure are directed to improving usability in a case where a scan is executed in such a manner as to leave a trace of correction.

According to embodiments of the present disclosure, an image processing apparatus includes a generation unit configured to generate original document data by reading an original document, a transmission unit configured to transmit the original document data generated by the generation unit, a first reception unit configured to receive an operation for providing an instruction to transmit the original document data by the transmission unit, a second reception unit configured to receive an operation for enabling a trace-of-correction setting being a setting to include, in the original document data generated by the generation unit, a trace of correction indicating that the original document has been corrected, and a first display unit configured to display a predetermined screen in a case where the first reception unit receives transmission of the original document data and the second reception unit receives the operation for enabling the trace-of-correction setting.

Further features of the present disclosure will become apparent from the following description of exemplary embodiments with reference to the attached drawings.

### BRIEF DESCRIPTION OF THE DRAWINGS

FIG. 1 is an overall view of an image processing system according to a first exemplary embodiment.

FIG. 2 is a block diagram illustrating a configuration of a multi-function (MFP) according to the first exemplary embodiment.

FIG. 3 is a diagram illustrating an application configuration according to the first exemplary embodiment.

FIGS. 4A, 4B, 4C, 4D, 4E, and 4F are diagrams each illustrating an example of a screen to be displayed on an operation display unit according to the first exemplary embodiment.

FIG. 5 is a flowchart illustrating an example of processing to be executed when a “leave a trace of a correction fluid or the like” button is pressed according to the first exemplary embodiment.

FIGS. 6A, 6B, and 6C are diagrams each illustrating an example of a screen to be displayed on an operation display unit in a case where a “leave a trace of a correction fluid or the like” setting is enabled according to the first exemplary embodiment.

FIG. 7 is a flowchart illustrating an example of setting screen display processing according to the first exemplary embodiment.

FIG. 8 is a flowchart illustrating an example of transmission destination selection/determination processing according to the first exemplary embodiment.

FIG. 9 is a diagram illustrating an example of an address book screen according to the first exemplary embodiment.

FIG. 10 is a flowchart illustrating an example of processing to be executed at the time of a scan start according to the first exemplary embodiment.

FIGS. 11A, 11B, and 11C are diagrams illustrating an example of an address book screen and a pop-up screen displayed at the time of a scan start according to the first exemplary embodiment.

FIG. 12 is a flowchart illustrating an example of processing to be executed at the time of a scan start according to a second exemplary embodiment.

FIG. 13 is a diagram illustrating an example of a pop-up screen to be displayed at the time of a scan start according to the second exemplary embodiment.

FIG. 14 is a flowchart illustrating error notification processing to be performed at the time of transmission destination selection according to a third exemplary embodiment.

FIG. 15 is a diagram illustrating an example of a pop-up screen to be performed at the time of transmission destination selection according to the third exemplary embodiment.

### DESCRIPTION OF THE EMBODIMENTS

Hereinafter, the present disclosure will be described in detail with reference to the drawings. The following exemplary embodiments are not intended to limit the present disclosure. In addition, not all combinations of features described in the present exemplary embodiment are always essential to the solution of the present disclosure. In the accompanying drawings, the same or similar components are assigned the same reference numerals, and redundant descriptions thereof will be omitted.

### <System Configuration>

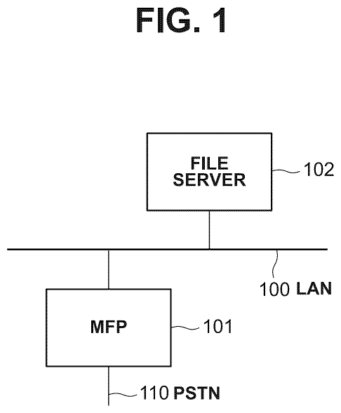

FIG. 1 is a diagram illustrating an example of an image processing system according to a first exemplary embodiment. On a local area network (LAN) 100, a multi-function peripheral (MFP) 101 and a file server 102 are communicably connected with each other. The MFP 101 is an example of an image processing apparatus. The file server 102 is an example of a file management apparatus (information processing apparatus). Nevertheless, the image processing system is not limited thereto as long as the MFP 101 is an image processing apparatus including a reading device. Alternatively, the MFP 101 may be a printer including a print function of printing image data on a sheet. The printing method of the printer may be an electrophotographic method, an inkjet method, or any other method.

The MFP 101 can perform file transmission of image data using a file transfer protocol to a folder in the file server 102 that is set as a destination. Examples of the file transfer protocol include Server Message Block (SMB) and a File Transfer Protocol (FTP). The file transmission destination of the MFP 101 is not limited to the file server 102, and a folder in a host personal computer (PC) (not illustrated) can also be set as the destination. The MFP 101 can also transmit image data by e-mail via an e-mail server (not illustrated). The MFP 101 is connected to a public switched telephone network (PSTN) 110, and can perform facsimile (fax) transmission and reception with a fax apparatus (not illustrated). In addition, the MFP 101 may be connected with the Internet (not illustrated) and configured to transmit data to another apparatus via the Internet.

If a destination table stored in a device (e.g., the file server 102) in the image processing system is laid open, the MFP 101 can acquire the destination table via the LAN 100 and use the destination table.

The image processing system includes the MFP 101 and the file server 102, but a system including only the MFP 101 can also be referred to as the image processing system. In addition, a system including a host PC (not illustrated) or a management server can also be referred to as the image processing system.

### <Hardware Configuration>

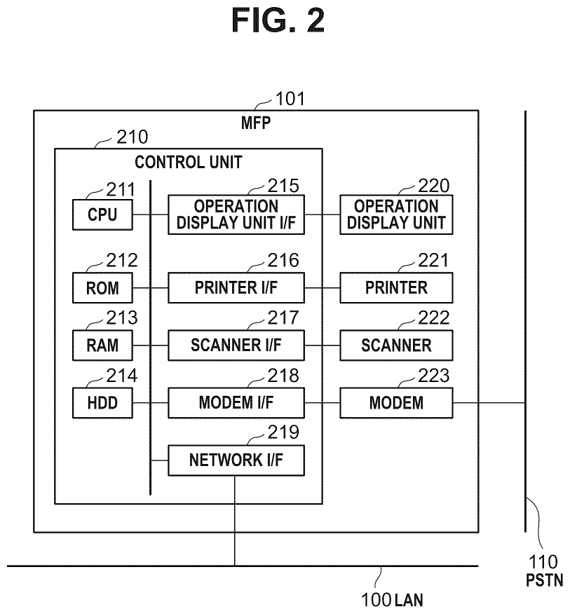

FIG. 2 is a block diagram illustrating an example of a hardware configuration of the MFP 101. The MFP 101 includes a control unit 210, an operation display unit 220, a printer 221, a scanner 222, and a modem 223. The control unit 210 includes a central processing unit (CPU) 211, a read-only memory (ROM) 212, a random access memory (RAM) 213, a hard disk drive (HDD) 214, an operation display unit interface (I/F) 215, a printer I/F 216, a scanner I/F 217, a modem I/F 218, and a network I/F 219.

The control unit 210 including the CPU 211 controls operation of the entire MFP 101. The CPU 211 performs various types of control such as reading control and transmission control by reading control programs stored in the ROM 212. The RAM 213 is used as a main memory of the CPU 211 and a temporary storage area such as a work area. The MFP 101 executes each piece of processing illustrated in a flowchart to be described below by one CPU 211 using one memory (the RAM 213 or the HDD 214), but another configuration may be employed. For example, the MFP 101 may be configured to execute each piece of processing to be described below by causing a plurality of CPUs and a plurality of RAMs or HDDs to operate in conjunction with each other.

The HDD 214 stores image data and various programs. The operation display unit I/F 215 connects the operation display unit 220 and the control unit 210. The operation display unit 220 includes a liquid crystal display unit having a touch panel function that can display information regarding the MFP 101 and receive an operation performed by a user, and a keyboard.

The printer I/F 216 connects the printer 221 and the control unit 210. Image data to be used for printing in the printer 221 is transferred from the control unit 210 via the printer I/F 216 and is printed on a recording medium in the printer 221.

The scanner I/F 217 connects the scanner 222 and the control unit 210. The scanner 222 generates image data (image file) by reading an image on an original document and inputs the generated image data (image file) to the control unit 210 via the scanner I/F 217. The MFP 101 can transmit the image data (image file) generated by the scanner 222 as a file or by e-mail.

The modem I/F 218 connects the modem 223 and the control unit 210. The modem 223 connects the control unit 210 (MFP 101) to the PSTN 110. The modem 223 executes fax transmission and reception with a fax apparatus on the PSTN 110.

The network I/F 219 connects the control unit 210 (MFP 101) to the LAN 100. The network I/F 219 transmits image data and information to an external apparatus (e.g., the file server 102) on the LAN 100 and receives various types of information from the external apparatus on the LAN 100.

### <Software Configuration>

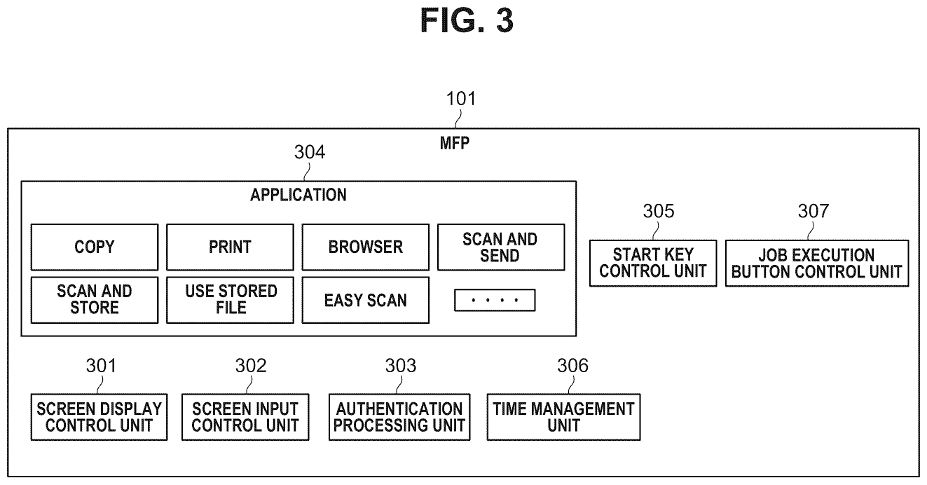

FIG. 3 is a block diagram illustrating an example of a software configuration of the MFP 101. In the present exemplary embodiment, unless otherwise stated, communication between software modules illustrated in FIG. 3 is implemented by the CPU 211 performing processing in accordance with a program stored in the ROM 212 or the HDD 214. The CPU 211 controls the ROM 212, the RAM 213, the HDD 214, the operation display unit I/F 215, the printer I/F 216, the scanner I/F 217, the modem I/F 218, and the network I/F 219.

The control unit 210 includes a screen display control unit 301, a screen input control unit 302, an authentication processing unit 303, an application 304, a start key control unit 305, a time management unit 306, and a job execution button control unit 307.

The screen display control unit 301 mainly performs screen management of the entire application 304, processing of transferring screen information to the operation display unit 220, and processing of notifying the application 304 of an event input from the operation display unit 220.

The operation display unit I/F 215 converts an operation from the operation display unit 220 into a signal, and the screen input control unit 302 receives and analyzes the signal and converts the signal into an input signal in the format of an event that can be transmitted to the application 304. Then, the screen input control unit 302 notifies the screen display control unit 301 of the input signal.

The authentication processing unit 303 displays an authentication screen on the operation display unit 220 and performs authentication of a user using authentication information such as an identification (ID) and a password entered by the user. In a case where the user authentication has succeeded, the authentication processing unit 303 performs login processing to log the user in to the MFP 101. When a logout instruction is issued, the authentication processing unit 303 performs logout processing to log the logged in user out of the MFP 101.

The application 304 is a group of applications operating on the MFP 101, and the CPU 211 operates each application in accordance with an instruction issued by the user via the screen input control unit 302. Among the applications included in the MFP 101, representative applications are as follows.
An application program having a “copy” function of printing, by the printer 221, image data generated by the scanner 222 reading an image on an original document.
An application program having a “print” function of printing image data by the printer 221 based on a print job input from an external apparatus such as a PC.
An application program having a “scan and send” function of transmitting image data generated by the scanner 222 reading an image on an original document to the outside.
An application program having a “scan and store” function of storing image data generated by the scanner 222 reading an image on an original document into an external memory.
An application program having a “use stored file” function of printing image data stored in an external memory by the printer 221 or transmitting the image data to the outside.
An application program having a “browser” function of browsing, printing, and storing data on a web server via a web browser.
An application program having an “easy scan” function of making the “scan and send” function easily-usable by limiting the “scan and send” function to only some major settings.

The application 304 included in the MFP 101 is not limited to the above-described example. In addition, an application program can be added to the application 304 afterward in accordance with an instruction issued by the user.

The start key control unit 305, when the screen input control unit 302 detects that a start key has been pressed, transmits a start key execution notification to the application 304. Upon receiving the start key execution notification, the application 304 executes a corresponding function.

The time management unit 306 manages a current time after the MFP 101 is started up, and notifies the user of the current time in accordance with an instruction from the start key control unit 305 or the job execution button control unit 307.

The job execution button control unit 307 makes a setting of a function of a corresponding application in accordance with an instruction from the user, and stores the setting in the HDD 214. The job execution button control unit 307 also detects that a registered job execution button has been pressed, invokes a corresponding application 304, and executes the application 304 with a setting pre-registered and stored in the HDD 214.

The components illustrated in FIG. 3 are merely examples, and the components are not limited to these examples. Some of the components illustrated in FIG. 3 may be omitted, and another component may be added.

Meanwhile, in Japan, the Electronic Books Maintenance Act has been amended, and scan data satisfying a specific condition is now accepted as an official document. The specific condition is that, for example, in a case where content has been corrected, the correction is to be confirmable (a trace of correction is to be confirmable) (Article 4.27 of the Act). In view of the foregoing, there has been known a method of automatically executing a job with a setting value for leaving a trace of correction in order to leave a correction trace.

Nevertheless, in a case where a setting value of a job is automatically changed to a setting value for leaving a trace of correction after a user performs a scan processing execution operation and the job is executed, the user may sometimes be unable to recognize the setting value with which the job has been executed. For example, in a case where the setting value is automatically changed to a setting value different from the setting value set by the user such that a trace of correction remains and the job is executed, a deliverable obtained by executing a scan is no longer a deliverable obtained by executing a scan with the setting value set by the user. In such a case, the user obtains a deliverable (scan data) of the scan executed with the setting value different from the setting value set by the user, which may deteriorate usability. Furthermore, in a case where a setting for leaving a trace of correction is enabled and a setting value of a setting related to the setting for leaving a trace of correction is changed by the user, a deliverable (scan data) in which a trace of correction remains may not be obtained.

Thus, in the present exemplary embodiment, in a case where the setting for leaving a trace of correction is enabled, the image processing apparatus notifies the user of a setting value with which a scan is to be executed. Specifically, in a case where the setting for leaving a trace of correction is enabled, the image processing apparatus displays a setting value of a setting item to be set such that a trace of correction remains (setting item related to the setting for leaving a trace of correction).

Accordingly, the user performs an operation of executing a job while recognizing a setting value with which a scan is to be executed. This reduces the possibility that scan data of a scan executed with a setting value different from the recognized setting value is obtained, which can improve the usability.

In the present exemplary embodiment, in a case where the setting for leaving a trace of correction is enabled, the image processing apparatus controls a setting value a change of which disables the setting for leaving a trace of correction (i.e., a setting value competing with the setting for leaving a trace of correction) to be unchangeable (unselectable), from among setting values of settings related to the setting for leaving a trace of correction. Specifically, in the case where the setting for leaving a trace of correction is enabled, the image processing apparatus displays the setting value the change of which disables the setting for leaving a trace of correction in a grayout state. Alternatively, the image processing apparatus hides the setting value the change of which disables the setting for leaving a trace of correction.

Accordingly, the possibility that the user unintentionally changes the setting value of the setting for leaving a trace of correction is reduced, which can improve the usability.

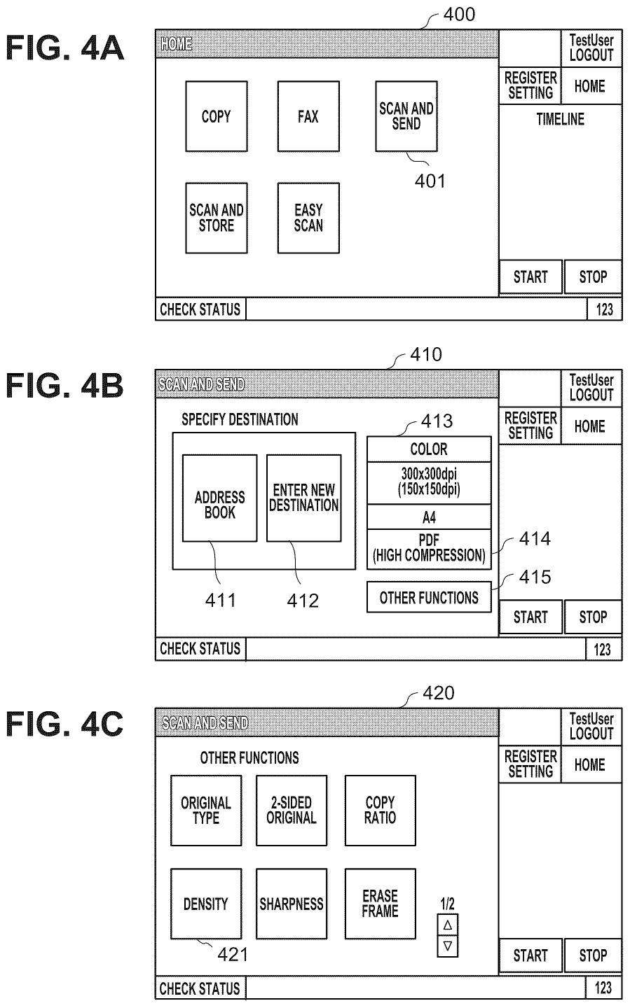

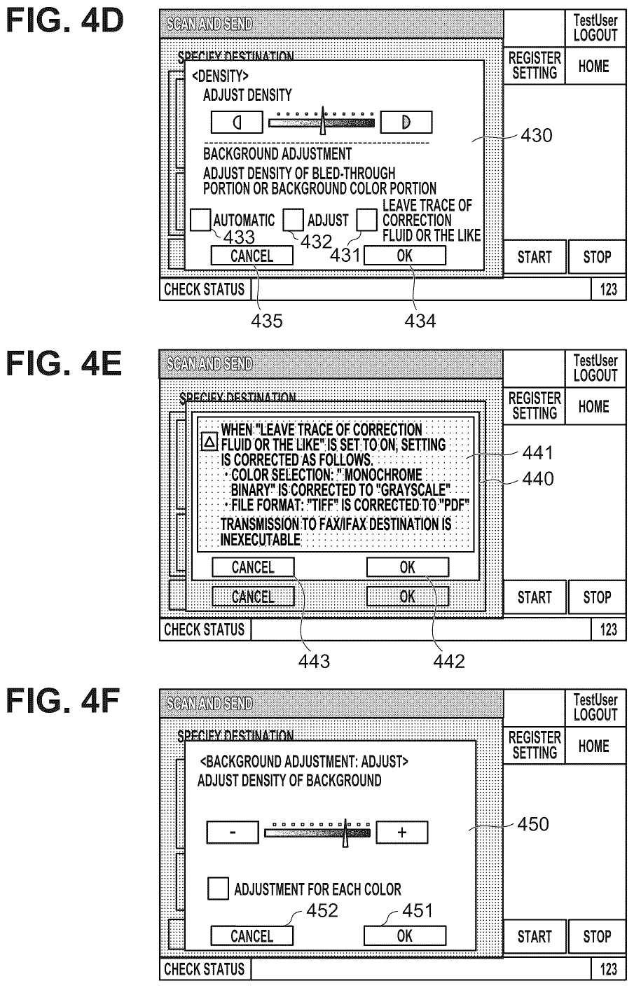

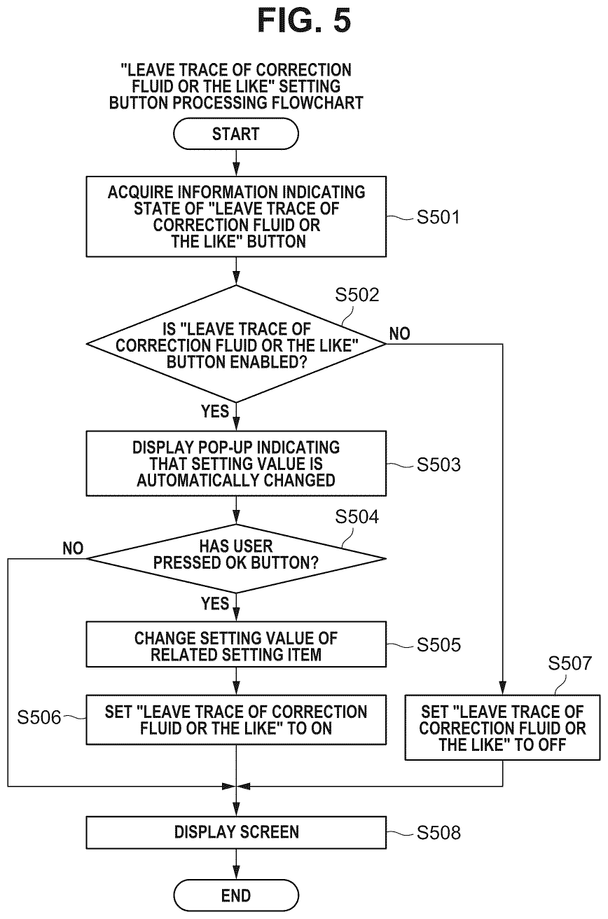

Hereinafter, an example of processing of changing setting values of a group of setting items related to the setting for leaving a trace of correction (in the present exemplary embodiment, density, color selection, file format, and background processing are handled as the related group of setting items) to specific values will be described with reference to FIGS. 4A, 4B, 4C, 4D, 4E, 4F, and 5.

### <Operation Screen>

FIGS. 4A, 4B, 4C, 4D, 4E, and 4F are diagrams each illustrating an example of a screen to be displayed on the operation display unit 220 according to the present exemplary embodiment. The screens illustrated in FIGS. 4A, 4B, 4C, 4D, 4E, and 4F are displayed by the screen display control unit 301. FIG. 4A illustrates an example of a home (menu) screen 400. On the home screen 400, icons for using the above-described application 304 are arranged. The home screen 400 illustrated in FIG. 4A is a screen to be initially displayed when the MFP 101 is started up, and is a screen to be displayed in response to a home button being pressed by the user on another screen. In the present exemplary embodiment, a configuration of using a scan-and-send application will be described as an example of the application 304 that uses the scanner 222.

FIG. 4B illustrates an example of a basic screen (hereinafter, referred to as a scan-and-send screen 410) of the scan-and-send application to be operated by the user. The scan-and-send screen 410 illustrated in FIG. 4B is displayed on the operation display unit 220 in response to a scan-and-send button 401 on the home screen 400 in FIG. 4A being pressed by the user. On the scan-and-send screen 410, destination buttons (an address book button 411 and a new destination button 412), setting buttons for major setting items (a color selection button 413, a file format selection button 414, a sheet selection button, etc.), and an other functions button 415 are provided. The description of buttons not given attention in the present exemplary embodiment will be omitted.

FIG. 4C illustrates an example of an other functions screen 420. The other functions screen 420 illustrated in FIG. 4C is displayed on the operation display unit 220 in response to the other functions button 415 on the scan-and-send screen 410 in FIG. 4B being pressed by the user. On the other functions screen 420, a button (e.g., a density button 421) for opening each setting screen is provided. The description of buttons not given attention in the present exemplary embodiment will be omitted.

FIG. 4D illustrates an example of a density setting screen 430. The density setting screen 430 illustrated in FIG. 4D is displayed on the operation display unit 220 in response to the density button 421 on the other functions screen 420 in FIG. 4C being pressed by the user. On the density setting screen 430, the user can make settings of density and background density. Here, the background density refers to a density setting limited to a background region excluding a character region and a figure region. On the density setting screen 430, an icon indicating a current density setting, an icon for changing the density setting, a “leave a trace of a correction fluid or the like” (trace-of-correction setting) button 431, a background density adjustment button 432, a background density automatic setting button 433, an OK button 434 for applying a setting change on the screen and closing the screen, and a cancel button 435 for closing the screen without applying the setting change are provided. The description of buttons not given attention in the present exemplary embodiment will be omitted. Here, in the present exemplary embodiment, the “leave a trace of a correction fluid or the like” button 431 is a button that can be used to collectively change one or more setting items related to the “leave a trace of a correction fluid or the like” setting. For example, in the present exemplary embodiment, if the “leave a trace of a correction fluid or the like” button 431 is pressed, setting values of a background density, color selection, a file format, and background color removal, which are related settings, are changed (step S505 to be described below). The background density is a setting item whose setting value can be changed on a background adjustment screen 450 to be described below, the color selection is a setting item whose setting value can be changed on a color selection screen 600 to be described below, and the file format is a setting item whose setting value can be changed on a file format screen 610 to be described below. On the other hand, the background color removal is a setting item for which a screen for the user to change its setting value is not provided. In the present exemplary embodiment, the “leave a trace of a correction fluid or the like” button 431 is arranged near the background density (on the density setting screen 430), which is a setting item with the strongest relation therewith among related settings, and the “leave a trace of a correction fluid or the like” button 431 is not arranged on the setting screens of the other setting items. In the present exemplary embodiment, the “leave a trace of a correction fluid or the like” button 431 enters either an enabled state or a disabled state, and when the “leave a trace of a correction fluid or the like” button 431 is enabled, the “leave a trace of a correction fluid or the like” button 431 becomes a highlighted state (for example, lights up in yellow).

FIG. 4E illustrates an example of a setting change confirmation pop-up 440. The setting change confirmation pop-up 440 illustrated in FIG. 4E is displayed on the operation display unit 220 in response to the “leave a trace of a correction fluid or the like” button 431 on the density setting screen 430 in FIG. 4D being pressed by the user and enabled. On the setting change confirmation pop-up 440, a message field 441, an OK button 442 for permitting setting change processing, and a cancel button 443 for refusing the setting change processing are provided. The description of buttons not given attention in the present exemplary embodiment will be omitted.

FIG. 4F illustrates an example of the background adjustment screen 450. The background adjustment screen 450 illustrated in FIG. 4F is displayed on the operation display unit 220 in response to the background density adjustment button 432 on the density setting screen 430 in FIG. 4D being pressed by the user. On the background adjustment screen 450, icons for background density adjustment, an OK button 451 for applying a change and closing the screen, and a cancel button 452 for rejecting a change and closing the screen are provided. The description of buttons not given attention in the present exemplary embodiment will be omitted. In a case where the background density automatic setting button 433 on the density setting screen 430 is pressed by the user, the background adjustment screen 450 is not displayed, and a background density is automatically adjusted at the time of job execution.

FIG. 5 is a flowchart illustrating an example of processing to be executed when the “leave a trace of a correction fluid or the like” button 431 is pressed. The processing in the flowchart illustrated in FIG. 5 is implemented by the CPU 211 of the MFP 101 loading a program for implementing each control module that is stored in the ROM 212 into the RAM 213 and executing the program. The function of some or all of the processing steps in FIG. 5 may be implemented by hardware such as an application specific integrated circuit (ASIC) and an electronic circuit. An alphabetical letter “S” in the description of each piece of processing indicates a step in the flowchart (the same applies to the flowcharts in the present specification).

The processing in the flowchart illustrated in FIG. 5 is started based on the user's press of the “leave a trace of a correction fluid or the like” button 431 on the density setting screen 430 in FIG. 4D.

In step S501, the screen display control unit 301 acquires information indicating a current state of the “leave a trace of a correction fluid or the like” button 431, and the processing proceeds to step S502. Specifically, the screen display control unit 301 acquires information indicating whether the state of the “leave a trace of a correction fluid or the like” button 431 is an enabled state or a disabled state.

In step S502, the screen display control unit 301 determines whether the state of the “leave a trace of a correction fluid or the like” button 431 that has been acquired in step S501 indicates the enabled state. More specifically, the screen display control unit 301 determines whether a user operation on the “leave a trace of a correction fluid or the like” button 431 on the density setting screen 430 in FIG. 4D is an operation of enabling a “leave a trace of a correction fluid or the like” setting. Here, since the state of the “leave a trace of a correction fluid or the like” button 431 is either the enabled state (ON) or the disabled state (OFF), when the “leave a trace of a correction fluid or the like” button 431 is pressed, the state transitions to the other state. More specifically, in a case where the “leave a trace of a correction fluid or the like” button 431 is pressed when the information acquired in step S501 is information indicating that the “leave a trace of a correction fluid or the like” setting is disabled, the screen display control unit 301 determines that the user operation on the “leave a trace of a correction fluid or the like” button 431 is an operation of enabling the “leave a trace of a correction fluid or the like” setting. On the other hand, in a case where the “leave a trace of a correction fluid or the like” button 431 is pressed when the information acquired in step S501 is information indicating that the “leave a trace of a correction fluid or the like” setting is enabled, the screen display control unit 301 determines that the user operation on the “leave a trace of a correction fluid or the like” button 431 is an operation of disabling the “leave a trace of a correction fluid or the like” setting. In a case where the screen display control unit 301 determines in step S502 that the user operation is the operation of enabling the “leave a trace of a correction fluid or the like” setting (YES in step S502), the processing proceeds to step S503. In a case where the screen display control unit 301 determines in step S502 that the user operation is the operation of disabling the “leave a trace of a correction fluid or the like” setting (NO in step S502), the processing proceeds to step S507.

In step S503, the screen display control unit 301 displays the setting change confirmation pop-up 440 in FIG. 4E on the operation display unit 220, and the processing proceeds to step S504.

In step S504, the screen display control unit 301 determines whether the user has pressed the OK button 442. Specifically, the screen display control unit 301 waits for a user operation (a press of the OK button 442 or a press of the cancel button 443), and determines whether the user operation performed is the press of the OK button 442 or the press of the cancel button 443. In a case where the screen display control unit 301 determines in step S504 that a button pressed by the user is the OK button 442 (YES in step S504), the setting change confirmation pop-up 440 is closed, and the processing proceeds to step S505. On the other hand, in a case where the screen display control unit 301 determines in step S504 that a button pressed by the user is not the OK button 442, i.e., determines that a button pressed by the user is the cancel button 443 (NO in step S504), the setting change confirmation pop-up 440 is closed, and the processing proceeds to step S508. A timing at which the setting change confirmation pop-up 440 is closed is not limited, and the setting change confirmation pop-up 440 may be closed in a case where the processing proceeds to step S508.

In step S505, the screen display control unit 301 performs correction (change) of a setting value of a setting item related to the “leave a trace of a correction fluid or the like” setting, and the processing proceeds to step S506. Here, in the present exemplary embodiment, the following correction processing is performed.
The background density is corrected to “maximum”.
In a case where “monochrome binary” is selected in the color selection, “monochrome binary” is corrected to “grayscale”.
In a case where “Tag Image File Format (TIFF)” is selected as a file format, “TIFF” is corrected to “Portable Document Format (PDF)”.
The background processing is corrected to “OFF”, and there is no corresponding setting screen.

In the present exemplary embodiment, the background density, the color selection, the file format, and the background processing described above are corrected, but the corrected items are not limited thereto. For example, only some of the above-described related setting items may be corrected, and a setting item other than the above-described related setting items may be corrected. Specifically, only the background density may be corrected, or in addition to the above-described related setting items, a sharpness (edge enhancement processing) setting may be changed to a default value, or a setting of preview display after reading may be enabled (set to ON).

In step S506, the screen display control unit 301 enables the “leave a trace of a correction fluid or the like” setting (sets the setting to ON), and the processing proceeds to step S508.

In step S507, the screen display control unit 301 disables the “leave a trace of a correction fluid or the like” setting (sets the setting to OFF), and the processing proceeds to step S508. In the present exemplary embodiment, in the case of disabling the “leave a trace of a correction fluid or the like” setting, correction processing of the setting value of the related setting item is not performed, but the configuration is not limited thereto. It is also possible to configure such that, for example, when the “leave a trace of a correction fluid or the like” setting is enabled, the setting value before a change is held in the RAM 213 or the like, and when the “leave a trace of a correction fluid or the like” setting is disabled, the setting value is restored.

In step S508, in a case where the “leave a trace of a correction fluid or the like” setting is enabled (set to ON), the screen display control unit 301 displays a density setting screen 620 to be described below, and in a case where the “leave a trace of a correction fluid or the like” setting is disabled (set to OFF), the screen display control unit 301 displays the density setting screen 430, and ends the processing in the flowchart. Here, an example in which the density setting screen 430 is displayed has been described, but the screen to be displayed is not limited thereto. For example, a screen to be displayed at the time of start-up (the home screen 400 in the present exemplary embodiment) may be displayed, or a default screen of each application (the scan-and-send screen 410 in the present exemplary embodiment) may be displayed. Alternatively, a screen for notifying the user of information of some sort may be displayed, or the above-described screen may be displayed after a user operation.

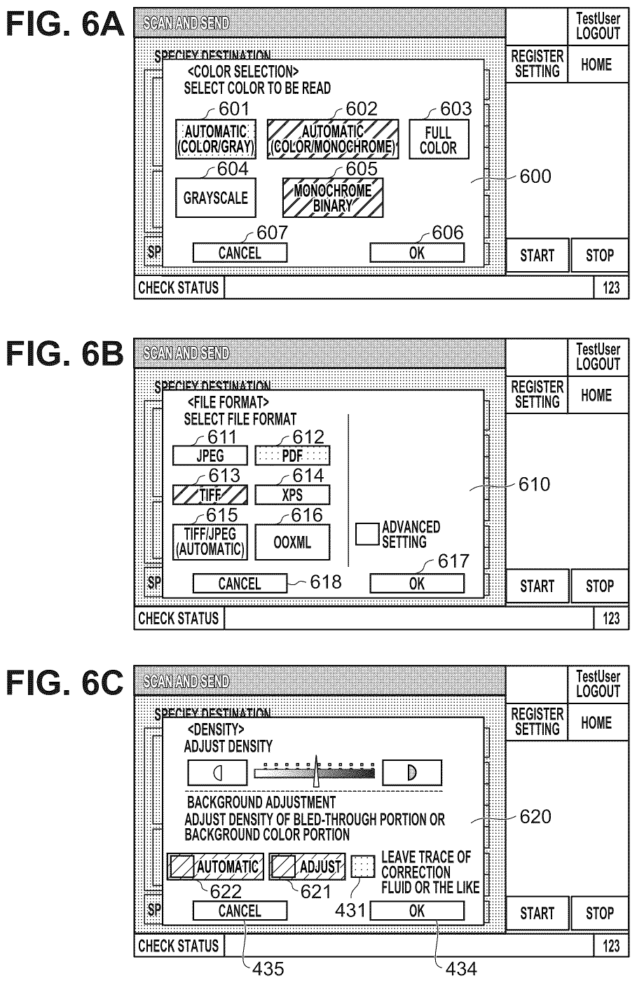

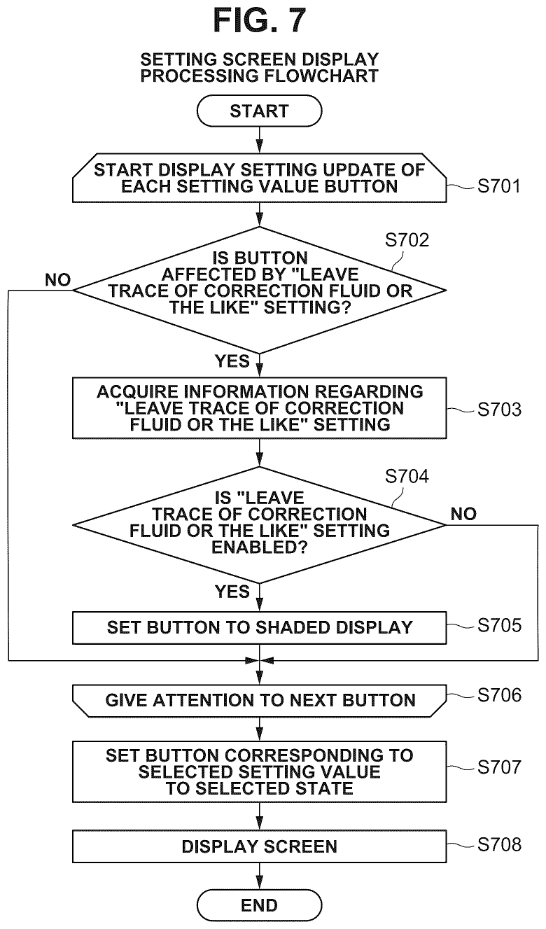

Hereinafter, display processing of displaying each setting screen in the scan-and-send application will be described with reference to FIGS. 6A, 6B, 6C, and 7. A setting screen to be given attention herein is each setting screen of each setting item to be affected by the “leave a trace of a correction fluid or the like” setting. Here, the setting item to be affected thereby is the setting item related to the “leave a trace of a correction fluid or the like” setting. For example, in the present exemplary embodiment, such a setting item includes the color selection (the color selection screen 600 is affected), the file format (the file format screen 610 is affected), and the background density (the density setting screen 620 is affected).

FIGS. 6A, 6B, and 6C are diagrams each illustrating an example of a setting screen of a setting item that is a candidate setting item for correction of a setting value in step S505 in a case where the “leave a trace of a correction fluid or the like” setting is enabled (set to ON). The screens illustrated in FIGS. 6A, 6B, and 6C are displayed on the operation display unit 220 by the screen display control unit 301.

FIG. 6A illustrates an example of the color selection screen 600. The color selection screen 600 illustrated in FIG. 6A is displayed on the operation display unit 220 in response to the color selection button 413 on the scan-and-send screen 410 in FIG. 4B being pressed. On the color selection screen 600, color setting value buttons 601 to 605, an OK button 606 for applying a setting change on the screen and closing the screen, and a cancel button 607 for closing the screen without applying the setting change are provided. The color setting value buttons 601 to 605 are associated with different setting values. In particular, the automatic (color/gray) button 601 and the automatic (color/monochrome) button 602 are associated with setting values each to be set to a color setting in a case where the scanner 222 detects, at the time of document reading, that a read document is a color document and to be set to the other setting value in other cases.

Here, based on the enabled (ON) state of the “leave a trace of a correction fluid or the like” setting, on the color selection screen 600, the selected color setting value button is highlighted, and the unavailable color setting value button is displayed in a shaded (grayout) state. For example, in the case of FIG. 6A, the automatic (color/gray) button 601 is selected, and display of the automatic (color/monochrome) button 602 and the monochrome binary button 605 is controlled to indicate the buttons are unavailable.

FIG. 6B illustrates an example of the file format screen 610. The file format screen 610 illustrated in FIG. 6B is displayed on the operation display unit 220 in response to the file format selection button 414 on the scan-and-send screen 410 in FIG. 4B being pressed. On the file format screen 610, file format setting value buttons 611 to 616, an OK button 617 for applying a setting change on the screen and closing the screen, and a cancel button 618 for closing the screen without applying the setting change are provided. The file format setting value buttons 611 to 616 are associated with different setting values. In particular, the TIFF/JPEG (automatic) button 615 is associated with a setting value to be set to TIFF in a case where it is detected by the scanner 222 at the time of document reading that a read document is a monochrome binary document, and to be set to Joint Photographic Experts Group (JPEG) in other cases. While the TIFF/JPEG (automatic) button 615 is still selectable, even if the TIFF/JPEG (automatic) button 615 is selected, an original document is read in a JPEG format. In a case where the TIFF/JPEG (automatic) button 615 is pressed, the user may be notified that the original document is not read in a TIFF format, i.e., the original document is read in a JPEG format.

Here, based on the enabled (ON) state of the “leave a trace of a correction fluid or the like” setting, on the file format screen 610, the selected file format setting value button is highlighted, and the unavailable file format setting value button is displayed in a shaded state. For example, in the case of FIG. 6B, the PDF button 612 is selected, and display of the TIFF button 613 is controlled to indicate the buttons are unavailable.

FIG. 6C illustrates an example of a density setting screen 620 to be displayed again in a case where the “leave a trace of a correction fluid or the like” setting is enabled (set to ON) by pressing the “leave a trace of a correction fluid or the like” button 431 on the density setting screen 430. Here, the “leave a trace of a correction fluid or the like” button 431 is highlighted. In a case where a background density is unchangeable, a background density adjustment button 621 and a background density automatic setting button 622 are displayed in a shaded state (for example, display as illustrated in FIG. 6C) and are unavailable.

FIG. 7 is a flowchart illustrating an example of display processing of displaying each of the setting screens illustrated in FIGS. 6A to 6C. The processing in the flowchart illustrated in FIG. 7 is implemented by the CPU 211 of the MFP 101 loading a program for implementing each control module that is stored in the ROM 212 into the RAM 213 and executing the program. The function of some or all of the processing steps in FIG. 7 may be implemented by hardware such as an ASIC and an electronic circuit.

The processing in the flowchart illustrated in FIG. 7 is started based on the user's press of any of the color selection button 413, the file format selection button 414, and the density button 421 on the scan-and-send screen 410 in FIG. 4B. A trigger to start the processing in the flowchart illustrated in FIG. 7 is not limited to the above. For example, the processing in the flowchart illustrated in FIG. 7 may be started also in a case where each of the setting screens illustrated in FIGS. 6A to 6C is displayed by any foreground screen being closed. Specifically, the processing in the flowchart illustrated in FIG. 7 may be started also based on the user's press of an OK button or a cancel button on the background adjustment screen 450 or the setting change confirmation pop-up 440.

In step S701, the screen display control unit 301 starts an update of a display setting for each button on the setting screen. Attention is given to a certain button on the setting screen, and the processing proceeds to step S702. For example, in a case where the processing in the flowchart is started based on a press of the color selection button 413, attention is given to any one of the color setting value buttons 601 to 605 illustrated in FIG. 6A. In the present exemplary embodiment, the OK button 606 and the cancel button 607 are not given attention in step S701, but may be configured such that attention is given to the OK button 606 or the cancel button 607.

In step S702, the screen display control unit 301 determines whether the button given attention is a button to be affected by the “leave a trace of a correction fluid or the like” setting. Here, the button to be affected by the “leave a trace of a correction fluid or the like” setting refers to a button associated with a setting value a change of which disables the setting of leaving a trace of a correction (i.e., a setting value competing with the setting of leaving a trace of correction). In a case where the screen display control unit 301 determines in step S702 that the button is a button to be affected by the “leave a trace of a correction fluid or the like” setting (YES in step S702), the processing proceeds to step S703. In a case where the screen display control unit 301 determines in step S702 that the button given attention is not a button to be affected by the “leave a trace of a correction fluid or the like” setting (NO in step S702), the processing proceeds to step S706. In the present exemplary embodiment, whether the button given attention is a button to be affected by the “leave a trace of a correction fluid or the like” setting is determined based on Table 1 provided below. While the density setting screen 430 is not a screen for changing a setting value of a setting item related to the “leave a trace of a correction fluid or the like” setting, the density setting screen 430 includes a button to be affected. This is to restrict screen transition to the background adjustment screen 450 for adjusting the background density, and the density setting screen 430 is configured such that the background density adjustment button 432 and the background density automatic setting button 433 on the density setting screen 430 are affected by the “leave a trace of a correction fluid or the like” setting.

TABLE 1

| | | Whether the button is |
|---|---|---|
| | | affected by “leave a trace |
| | | of a correction fluid |
| Setting screen | Button | or the like” setting |
| Color | Automatic (color/gray) | Not affected |
| selection | Automatic | Affected |
| screen | (color/monochrome) | |
| | Full color | Not affected |
| | Grayscale | Not affected |
| | Monochrome binary | Affected |
| File format | JPEG | Not affected |
| screen | PDF | Not affected |
| | TIFF | Affected |
| | XPS | Not affected |
| | TIFF/JPEG (automatic) | Not affected |
| | OOXML | Not affected |
| Density | Automatic | Affected |
| setting screen | Adjust | Affected |

In the case of the color selection screen 600, the automatic (color/monochrome) button 602 and the monochrome binary button 605 are buttons associated with setting values to be affected. Then, the buttons associated with the other setting values are buttons associated with setting values not to be affected.

In step S703, the screen display control unit 301 acquires information regarding the current “leave a trace of a correction fluid or the like” setting from the RAM 213, and the processing proceeds to step S704.

In step S704, the screen display control unit 301 determines whether the “leave a trace of a correction fluid or the like” setting acquired in step S703 is enabled (set to ON). In a case where the screen display control unit 301 determines in step S704 that the “leave a trace of a correction fluid or the like” setting is enabled (YES in step S704), the processing proceeds to step S705. In a case where the screen display control unit 301 determines in step S704 that the “leave a trace of a correction fluid or the like” setting is disabled (set to OFF) (NO in step S704), the processing proceeds to step S706.

In step S705, the screen display control unit 301 sets the button given attention to shaded display, and the processing proceeds to step S706. For example, in the case of the color selection screen 600, in a case where it is determined that the “leave a trace of a correction fluid or the like” setting is enabled (set to ON) (YES in step S704), the processing proceeds to step S705 for both the automatic (color/monochrome) button 602 and the monochrome binary button 605, and the automatic (color/monochrome) button 602 and the monochrome binary button 605 are set to shaded display in step S705. Here, in the present exemplary embodiment, an unavailable state of the buttons is indicated to the user by shaded display, but the display is not limited thereto. For example, in a case where a button is unavailable, the button on the screen may not be displayed (the button may be hidden), or a screen displaying a message indicating that the button is unavailable may be displayed when the button is pressed without changing the display on a setting screen.

In step S706, in a case where a next button on which the processing in steps S701 to S706 has not been executed yet exists in the setting screen, the screen display control unit 301 advances the processing to step S701 with the attention given to the next button. In a case where the next button does not exist, the processing proceeds to step S707.

In step S707, the screen display control unit 301 acquires a currently-selected setting value from the RAM 213, and sets a button corresponding to the setting value to a selected state. For example, in the case of FIG. 6A, the automatic (color/gray) button 601 is set to the selected state, and in the case of FIG. 6B, the PDF button 612 is set to the selected state.

In step S708, the screen display control unit 301 displays a setting screen corresponding to any button of the color selection button 413, the file format selection button 414, and the density button 421 that has been pressed when the processing in the flowchart is started, and ends the processing in the flowchart. For example, in a case where the processing in the flowchart is started by the press of the color selection button 413, in step S708, the color selection screen 600 is displayed.

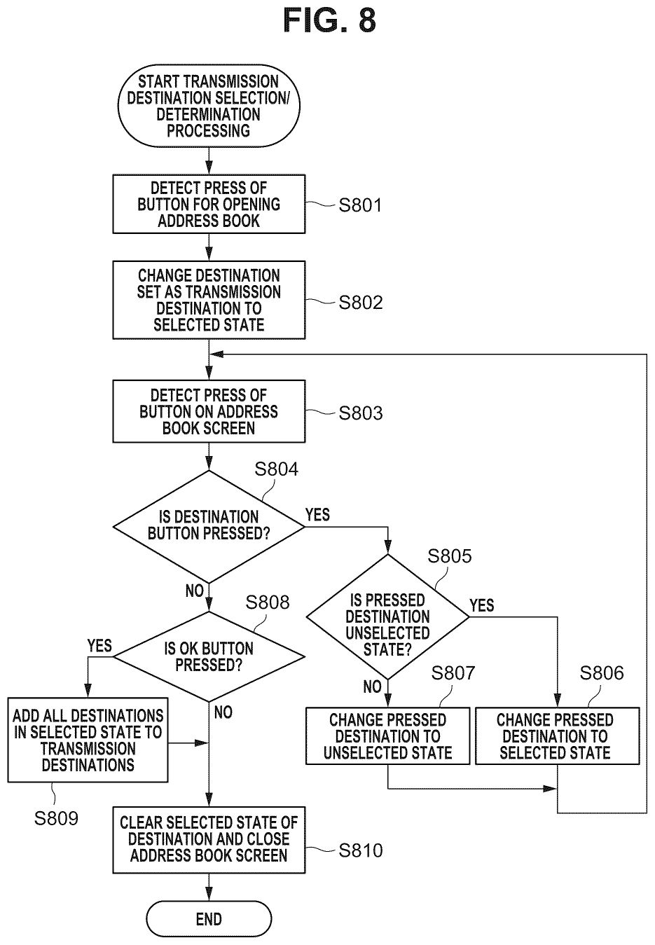

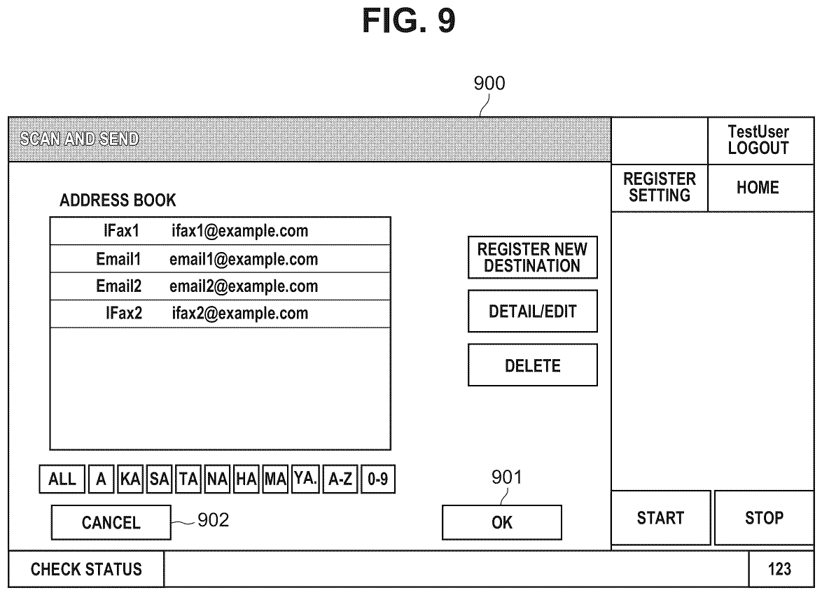

Hereinafter, transmission destination selection/determination processing to be executed in the scan-and-send application will be described with reference to FIGS. 8 and 9.

FIG. 8 is a flowchart illustrating the transmission destination selection/determination processing to be performed in the scan-and-send application.

In step S801, the operation display unit 220 detects a press of a button for opening an address book. In the present exemplary embodiment, a destination is selected as a transmission destination from among destinations pre-registered in the address book, but the transmission destination may be directly entered.

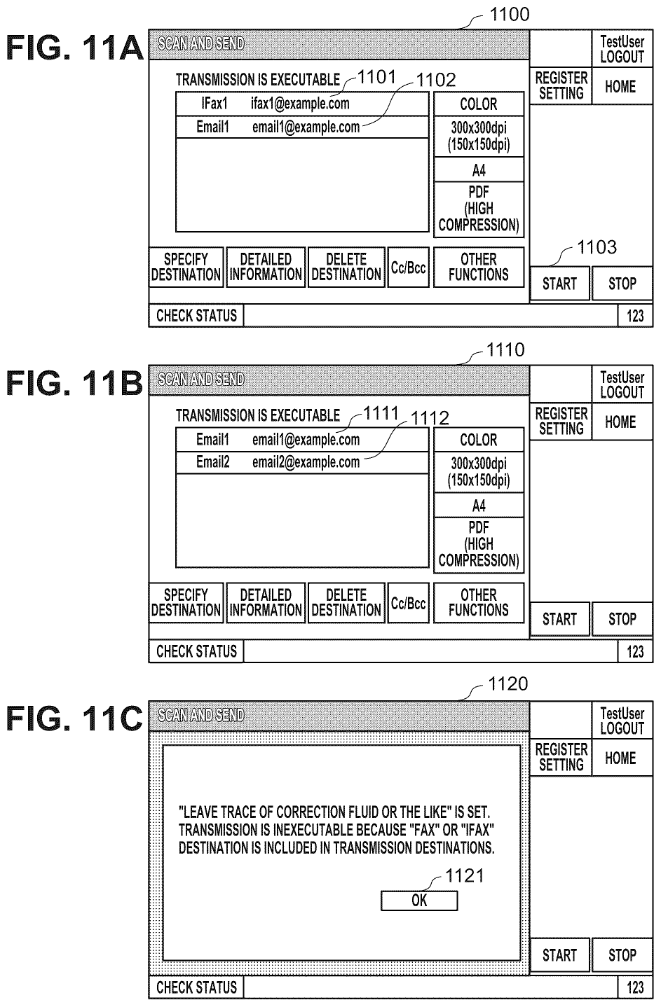

In step S802, the operation display unit 220 displays an address book screen. In a case where the address book screen is displayed upon the press of the address book button 411 on the scan-and-send screen 410, all destinations are displayed in an unselected state. On the other hand, in a case where the address book screen is displayed upon a press of a “specify destination” button on a scan-and-send application basic screen (FIGS. 11A and 11B to be described below), the state of a destination already set as the transmission destination before the start of the processing in the flowchart is changed to the selected state. When the processing in step S802 ends, the processing proceeds to step S803.

Here, FIG. 9 illustrates an example of an address book screen to be displayed when the button for opening an address book is pressed. The address book screen is a screen to be displayed when the address book button 411 in FIG. 4B is pressed. On this address book screen, by highlighting a selected destination, the user is notified that the destination is in the selected state. FIG. 9 illustrates the address book screen in a state in which no destination is selected (state in which the address book is opened with a destination being unselected).

In step S803, the operation display unit 220 detects the press of a button on the address book screen. Then, the processing proceeds to step S804.

In a case where the operation display unit 220 determines that the button having been pressed is a destination in an unselected state (in a case where it is determined in step S804 that a destination button has been pressed (YES in step S804), and it is determined in step S805 that the pressed destination is in the unselected state (YES in step S805)), the processing proceeds to step S806. In step S806, the selected destination is changed to the selected state, and the processing returns to step S803.

In a case where the operation display unit 220 determines that the button having been pressed is an already-selected destination (in the case where it is determined in step S804 that a destination button has been pressed (YES in step S804), and it is determined in step S805 that the pressed destination is not in the unselected state (NO in step S805)), the processing proceeds to step S807. In step S807, the selected destination is changed to the unselected state, and the processing returns to step S803. On the address book screen, by returning the selected destination in a highlighted state to an original state, the user is notified that the selection is canceled.

In a case where the operation display unit 220 determines that the button having been pressed is an OK button (in a case where it is determined in step S808 that the OK button has been pressed) (YES in step S808)), the processing proceeds to step S809. In step S809, all destinations in the selected state are set as (added to) transmission destinations. Then, the processing proceeds to step S810.

In a case where the operation display unit 220 determines that the button having been pressed is a cancel button (in a case where it is determined in step S808 that the cancel button has been pressed) (NO in step S808)), the processing proceeds to step S810. In step S810, the operation display unit 220 clears the selected state of all the destinations. In other words, the operation display unit 220 changes all the destinations to the unselected state. Then, the operation display unit 220 closes the address book screen, displays the scan-and-send application basic screen (to be described below with reference to FIGS. 11A and 11B), and ends the processing in the flowchart.

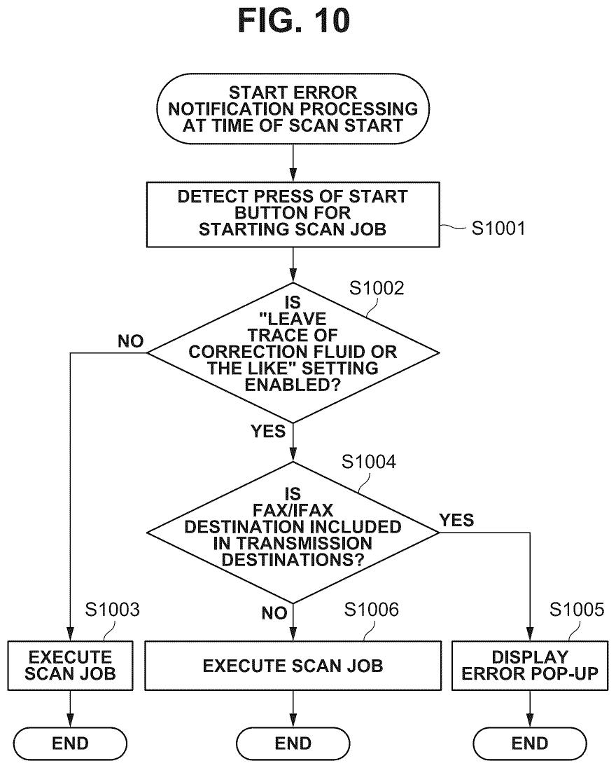

Hereinafter, error notification processing to be performed at the time of a scan start will be described with reference to FIGS. 10, 11A, 11B, and 11C.

FIG. 10 is a flowchart illustrating error notification processing to be performed at the time of a scan start.

In step S1001, the job execution button control unit 307 detects a press of a start button for starting a scan job. When the press of the start button is detected, the processing proceeds to step S1002.

FIGS. 11A and 11B each illustrate an example of the scan-and-send application basic screen displayed after transmission destinations are selected on the address book screen illustrated in FIG. 9.

FIG. 11A illustrates a basic screen 1100 to be displayed in a case where the transmission destinations include a facsimile (FAX)/Internet fax (IFAX) destination, and illustrates an example in which transmission destinations 1101 and 1102 and a start button 1103 are displayed. The button for starting a scan job in step S1001 may be the start button 1103 displayed on the basic screen 1100, or may be a hardware key start button (not illustrated). FIG. 11B illustrates a basic screen 1110 to be displayed in a case where the transmission destinations do not include a FAX/IFAX destination, and illustrates an example in which transmission destinations 1111 and 1112 are displayed.

In a case where the “leave a trace of a correction fluid or the like” setting is disabled in step S1002 (NO in step S1002), the processing proceeds to step S1003. In step S1003, the CPU 211 executes a scan job and ends the processing in the flowchart. In a case where the “leave a trace of a correction fluid or the like” setting is enabled in step S1002 and the transmission destinations do not include a FAX/IFAX destination (YES in step S1002 and NO in step S1004), the processing proceeds to step S1006. In step S1006, the CPU 211 executes a scan job and ends the processing in the flowchart.

On the other hand, in a case where the transmission destinations include one or more FAX/IFAX destinations (in a case where it is determined in step S1002 that the “leave a trace of correction fluid” setting is enabled (YES in step S1002) and it is determined in step S1004 that transmission destinations include a FAX/IFAX destination (YES in step S1004), the processing proceeds to step S1005. In step S1005, the screen display control unit 301 displays an error pop-up and ends the processing in the flowchart. FIG. 11C illustrates an example of the error pop-up to be displayed at the time of transmission. In a case where an OK button 1121 is pressed by the user, the screen display control unit 301 closes the error pop-up screen.

The FAX/IFAX (fax function) is a function of transmitting a binarized original document, and in the binarized original document, a trace of a correction fluid or the like sometimes does not remain correctly. Thus, in the present exemplary embodiment, it is assumed that even if the “leave a trace of a correction fluid or the like” setting is enabled, in a case where the transmission destinations of scan data include a FAX/IFAX destination as illustrated in FIG. 11A, job execution is stopped.

As described above, in the present exemplary embodiment, the MFP 101 can implement a setting for leaving a trace of a correction fluid or the like by the press of the “leave a trace of a correction fluid or the like” button. Then, by applying a changed setting value in the color selection screen 600 (FIG. 6A), the file format screen 610 (FIG. 6B), or the density setting screen 620 (FIG. 6C), it is possible to notify the user of the change. The user can accordingly check (recognize) settings of a job to be executed before execution of the job. Further, the user may be collectively notified of changed setting values using a pop-up screen.

In the above-described exemplary embodiment, after the “leave a trace of a correction fluid or the like” button is pressed on the MFP 101, each setting screen related to the “leave a trace of a correction fluid or the like” setting is displayed in a state in which a setting value is unchangeable. The MFP 101 can accordingly reduce a possibility of unintentionally disabling the “leave a trace of a correction fluid or the like” setting that has been intentionally set by the user.

In the above-described exemplary embodiment, after the “leave a trace of a correction fluid or the like” button is pressed, in a case where job transmission is executed with a FAX/IFAX destination being selected as a transmission destination, the MFP 101 displays an error pop-up. Thus, the MFP 101 can notify the user that a trace of correction cannot be left in original document data transmitted to a FAX/IFAX destination.

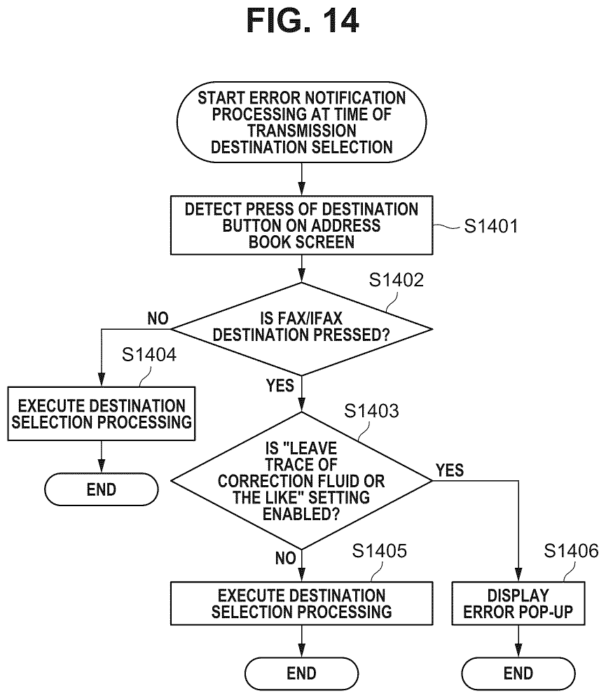

In the above-described exemplary embodiment, an example in which a setting value of a related setting item is changed to a specific setting value in a case where the “leave a trace of a correction fluid or the like” button is pressed has been described, but the example is not limited thereto. For example, in a case where the related setting item has a plurality of selectable candidate setting values, the user may be prompted to select a setting value. Specifically, a screen for selecting a setting value (for example, a screen to be described below with reference to FIG. 14) may be displayed on the operation display unit 220.

Next, a second exemplary embodiment will be described. In the first exemplary embodiment, in a case where the user enables the “leave a trace of a correction fluid or the like” setting and then starts a scan-and-send to a FAX/IFAX destination, the user is notified that a trace of a correction fluid or the like cannot be left in the transmission to a FAX/IFAX destination.

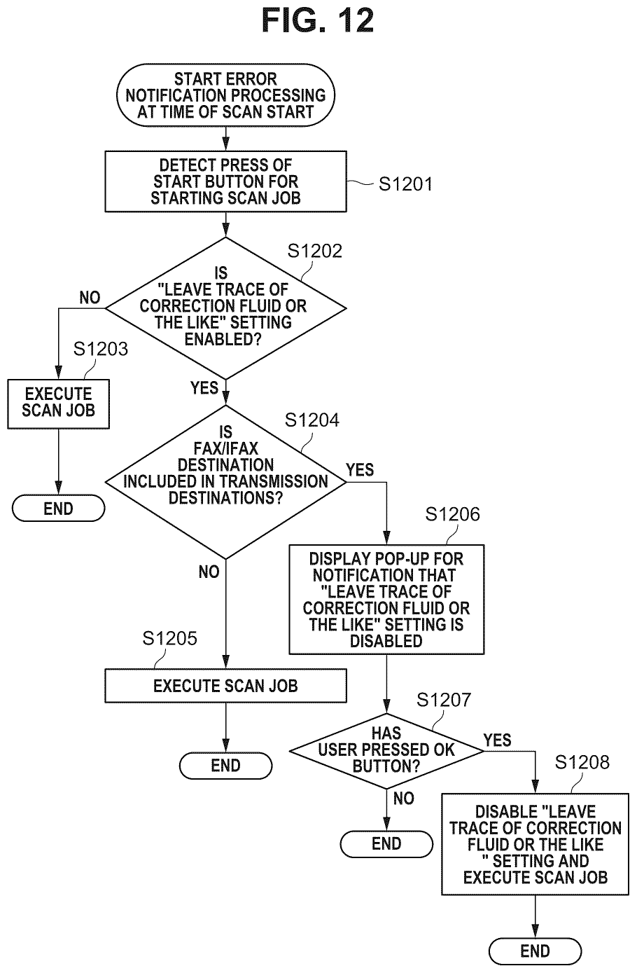

In the present exemplary embodiment, a method of notifying the user that the “leave a trace of a correction fluid or the like” setting is disabled and then transmission is performed instead of notifying the user that a trace of a correction fluid or the like is not left will be described. The components already described in the first exemplary embodiment are assigned the same reference numerals, and descriptions thereof will be omitted. The present exemplary embodiment differs from the first exemplary embodiment particularly in that error notification processing to be executed by the screen display control unit 301 at the time of a scan start is changed from the error notification processing illustrated in FIG. 10 to error notification processing illustrated in FIG. 12.

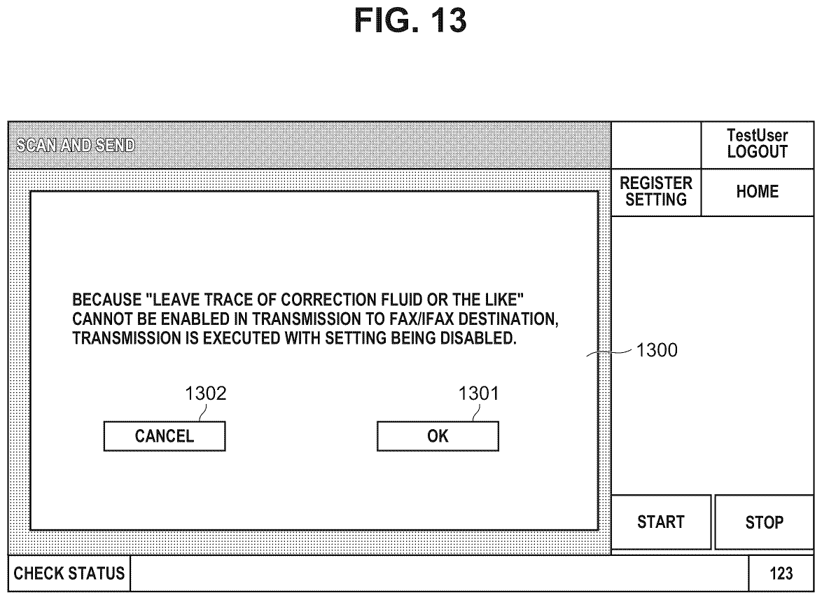

Hereinafter, the error notification processing to be executed at the time of transmission destination selection according to the present exemplary embodiment will be described with reference to FIGS. 12 and 13. FIG. 12 is a flowchart illustrating setting change notification processing to be performed at the time of a scan start. A scan-and-send application basic screen to be displayed after the transmission destination selection in the present exemplary embodiment is a screen similar to the screens illustrated in FIGS. 11A and 11B.

First, in step S1201, the job execution button control unit 307 detects a press of a start button 1103 for starting a scan job. When the press of the start button 1103 is detected, the processing proceeds to step S1202.

In step S1202, the screen display control unit 301 determines whether the “leave a trace of a correction fluid or the like” setting is enabled. In a case where the “leave a trace of a correction fluid or the like” setting is disabled (NO in step S1202), the processing proceeds to step S1203. In step S1203, the CPU 211 executes a scan job. On the other hand, in a case where it is determined that the “leave a trace of a correction fluid or the like” setting is enabled (YES in step S1202) and transmission destinations do not include a FAX/IFAX destination (NO in step S1204), the processing proceeds to step S1205. In step S1205, the CPU 211 executes a scan job with the “leave a trace of a correction fluid or the like” setting being enabled. In a case where the “leave a trace of a correction fluid or the like” setting is enabled (YES in step S1202) and the transmission destinations include one or more FAX/IFAX destinations (YES in step S1204), the processing proceeds to step S1206. In step S1206, the screen display control unit 301 displays a pop-up screen.

FIG. 13 is a diagram illustrating an example of a pop-up screen to be displayed at the time of a scan start according to the present exemplary embodiment. In FIG. 13, in a case where the user presses an OK button 1301 or a cancel button 1302, the screen display control unit 301 closes a pop-up screen 1300.

Description is again provided with reference to FIG. 12. In a case where the user has pressed the OK button 1301 on the pop-up screen 1300 (YES in step S1207), the processing proceeds to step S1208. In step S1208, the CPU 211 disables the “leave a trace of a correction fluid or the like” setting and executes a transmission job to a selected destination. Disabling the “leave a trace of a correction fluid or the like” setting in step S1208 is temporary processing, and the CPU 211 enables the “leave a trace of a correction fluid or the like” setting again after execution of the transmission job. On the other hand, in a case where the user has pressed the cancel button 1302 on the pop-up screen 1300 (NO in step S1207), the CPU 211 ends the processing without executing the transmission job.

In the present exemplary embodiment, the pop-up screen 1300 is displayed in step S1206, but the configuration is not limited thereto. In the case where the “leave a trace of a correction fluid or the like” setting is enabled and the transmission destinations include one or more FAX/IFAX destinations, the “leave a trace of a correction fluid or the like” setting may be disabled, and the transmission job to a selected destination may be executed without displaying the pop-up screen 1300 (without confirmation being made by the user). Whether to display or not display the pop-up screen 1300 may be made switchable by the setting of the main body of the MFP 101.

As described above, in the present exemplary embodiment, a setting value change notification is provided without an error notification being provided at the start time of a job (scan-and-send to a FAX/IFAX destination) as in the first exemplary embodiment. More specifically, a notification indicating that the “leave a trace of a correction fluid or the like” setting is disabled and then transmission is performed is provided. Thus, the user recognizes that a trace of a correction fluid or the like is not left in the transmission to a FAX/IFAX destination and can perform, in a case where the “leave a trace of a correction fluid or the like” setting can be disabled, the transmission to a FAX/IFAX destination by pressing an OK button on a pop-up screen.

Next, a third exemplary embodiment will be described. In the first exemplary embodiment, in a case where the user enables the “leave a trace of a correction fluid or the like” setting and then starts a scan-and-send to a FAX/IFAX destination, the user is notified that a trace of correction fluid or the like is not left in the transmission to a FAX/IFAX destination. In the present exemplary embodiment, a method of notifying the user that a trace of a correction fluid or the like is not left at a time point at which a FAX/IFAX destination is designated will be described as an example. The components already described in the first and second exemplary embodiments are assigned the same reference numerals, and descriptions thereof will be omitted.

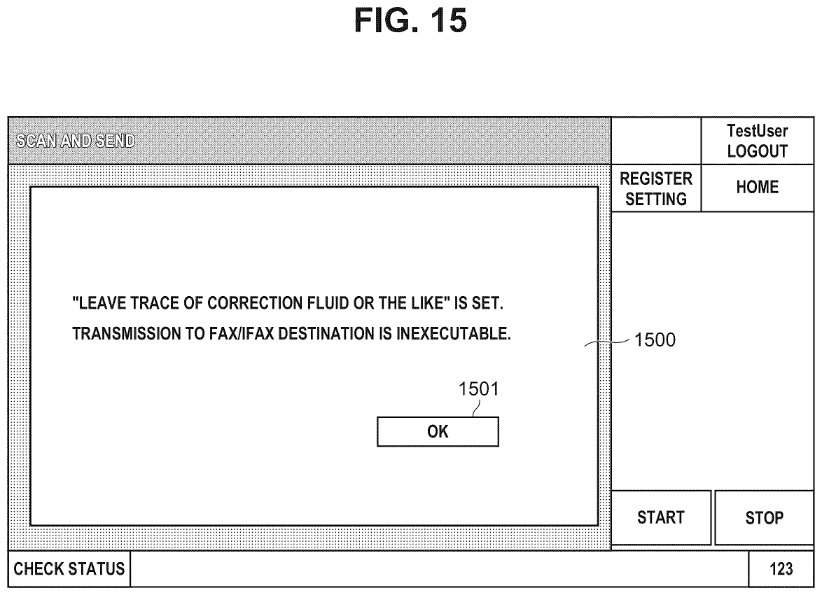

The present exemplary embodiment differs from the first exemplary embodiment particularly in that the screen display control unit 301 performs error notification processing at the time of transmission destination selection that is illustrated in FIG. 14 in place of the error notification processing at the time of a scan start that is illustrated in FIG. 10. Hereinafter, the error notification processing at the time of transmission destination selection according to the present exemplary embodiment will be described with reference to FIGS. 14 and 15.

FIG. 14 is a flowchart illustrating the error notification processing at the time of transmission destination selection according to the present exemplary embodiment. First, in step S1401, the operation display unit 220 detects a press of a destination button on an address book screen. Here, the address book screen is a screen similar to the address book screen described in the first exemplary embodiment with reference to FIG. 9. In a case where the operation display unit 220 determines that the destination pressed on the operation display unit 220 is not a FAX/IFAX destination (NO in step S1402), the processing proceeds to step S1404. In step S1404, the pressed destination is selected.

On the other hand, in a case where the operation display unit 220 determines that the destination pressed on the operation display unit 220 is a FAX/IFAX destination (YES in step S1402), the processing proceeds to step S1403. In step S1403, the screen display control unit 301 determines whether the “leave a trace of a correction fluid or the like” setting is enabled. In a case where the screen display control unit 301 determines that the “leave a trace of a correction fluid or the like” setting is disabled (NO in step S1403), the processing proceeds to step S1405. In step S1405, the pressed destination is selected. The destination selection processing in steps S1404 and S1405 is similar to the processing in steps S805 to S807 of FIG. 8 according to the first exemplary embodiment.

On the other hand, in a case where the operation display unit 220 determines that the pressed destination is a FAX/IFAX destination (YES in step S1402) and the “leave a trace of a correction fluid or the like” setting is enabled (YES in step S1403), the processing proceeds to step S1406. In step S1406, the screen display control unit 301 displays an error pop-up for notifying the user that a FAX/IFAX destination is unselectable.

FIG. 15 illustrates an example of a pop-up screen to be displayed in step S1406 according to the present exemplary embodiment.

In response to the user pressing an OK button 1501, the screen display control unit 301 closes a pop-up screen 1500.

In the present exemplary embodiment, because the error notification is provided when a FAX/IFAX destination is selected, in place of an error notification to be provided at the time of a scan start in the first exemplary embodiment, the user can recognize that a trace of a correction fluid or the like is not left at an earlier timing.

In the present exemplary embodiment, the error notification is provided only when a FAX/IFAX destination is selected, but the error notification may be used together with the error notification provided at the time of a scan start in the first exemplary embodiment. In a case where both of the error notifications are used together, it is possible to notify the user that a trace of a correction fluid or the like is not left not only for a FAX/IFAX destination registered in an address book but also for a FAX/IFAX destination directly entered on the scan-and-send application. In the above-described exemplary embodiments, it is determined whether transmission destinations include a FAX/IFAX destination. Alternatively, in a case where only a FAX/IFAX is included as a transmission function, for example, the configuration of determining whether the transmission destinations include a FAX/IFAX destination is not necessarily required.

The above-described exemplary embodiments can be implemented also by executing the following processing. More specifically, the processing is processing of supplying software (program) for implementing the functions of the above-described exemplary embodiments to a system or an apparatus via a network or various kinds of storage media, and a computer (a CPU, a micro processing unit (MPU), etc.) of the system or the apparatus reading the program and executing the program. The program may be executed by one computer, or may be executed by a plurality of computers in cooperation. Not all of the above-described processing needs to be implemented by software, and part or all of the processing may be implemented by hardware such as an ASIC. The CPU is not limited to a single CPU configured to perform all the processing, and a plurality of CPUs may perform the processing in conjunction with each other as appropriate.

The functions of the above-described exemplary embodiments are implemented not only by a computer executing a read program code. A case where an operating system (OS) operating on the computer performs part or all of actual processing based on an instruction of the program code, and the functions of the above-described exemplary embodiments are implemented by the processing is also included.

The usability can be improved in a case where a scan is executed in such a manner as to leave a trace of correction.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-014588, filed Feb. 2, 2024, which is hereby incorporated by reference herein in its entirety.

What is claimed is:

1. An image processing apparatus comprising:
a generation unit configured to generate original document data by reading an original document;
a transmission unit configured to transmit the original document data generated by the generation unit;
a first reception unit configured to receive an operation for providing an instruction to transmit the original document data by the transmission unit;
a second reception unit configured to receive an operation for enabling a trace-of-correction setting being a setting to include, in the original document data generated by the generation unit, a trace of correction indicating that the original document has been corrected; and
a first display unit configured to display a predetermined screen in a case where the first reception unit receives transmission of the original document data and the second reception unit receives the operation for enabling the trace-of-correction setting.

2. The image processing apparatus according to claim 1, wherein the predetermined screen is a screen that displays a message for notifying that the original document data cannot be transmitted in a state where the trace-of-correction setting is enabled.

3. The image processing apparatus according to claim 1, wherein, in a case where the second reception unit receives the operation for enabling the trace-of-correction setting in a state where the first reception unit has already received the transmission of the original document data, the first display unit displays the predetermined screen.

4. The image processing apparatus according to claim 1, wherein, in a case where the first reception unit receives the transmission of the original document data in a state where the second reception unit has already received the operation for enabling the trace-of-correction setting, the first display unit displays the predetermined screen.

5. The image processing apparatus according to claim 1, wherein the transmission unit transmits the original document data by facsimile (FAX) or Internet FAX (IFAX).

6. The image processing apparatus according to claim 5, further comprising a determination unit configured to determine whether a transmission destination of the original document data includes a transmission destination to which the original document data is to be transmitted by FAX or IFAX.

7. The image processing apparatus according to claim 6, wherein, in a case where the determination unit determines that the transmission destination of the original document data includes the transmission destination to which the original document data is to be transmitted by FAX or IFAX, the first display unit displays the predetermined screen.

8. An image processing apparatus comprising:
a generation unit configured to generate original document data by reading an original document;
a transmission unit configured to transmit the original document data generated by the generation unit;
a first reception unit configured to receive an operation of instructing the transmission unit to transmit the original document data; and
a second reception unit configured to receive an operation for enabling a trace-of-correction setting being a setting to include, in the original document data generated by the generation unit, a trace of correction indicating that the original document has been corrected,
wherein, in a case where the first reception unit receives transmission of the original document data and the second reception unit receives the operation for enabling the trace-of-correction setting, the transmission unit transmits the original document data in a state where the trace-of-correction setting is disabled.

9. The image processing apparatus according to claim 8, further comprising a first display unit configured to display a predetermined screen for prompting a user to select whether to transmit the original document data in a state where the trace-of-correction setting is disabled in the case where the first reception unit receives the transmission of the original document data and the second reception unit receives the operation for enabling the trace-of-correction setting.

10. The image processing apparatus according to claim 9, wherein a setting of whether to display the predetermined screen can be performed.

11. The image processing apparatus according to claim 8, wherein the transmission unit transmits the original document data by FAX or IFAX.

12. The image processing apparatus according to claim 11, further comprising a determination unit configured to determine whether a transmission destination of the original document data includes a transmission destination to which the original document data is to be transmitted by FAX or IFAX.

13. The image processing apparatus according to claim 12, wherein, in a case where the determination unit determines that the transmission destination of the original document data includes the transmission destination to which the original document data is to be transmitted by FAX or IFAX, the transmission unit transmits the original document data in a state where the trace-of-correction setting is disabled.

14. The image processing apparatus according to claim 8, wherein, after the transmission unit transmits the original document data in a state where the trace-of-correction setting is disabled, the transmission unit returns the trace-of-correction setting to an enabled state.

15. The image processing apparatus according to claim 1, further comprising a second display unit configured to display a setting screen of a setting related to the trace-of-correction setting.

16. The image processing apparatus according to claim 15, wherein, in a case where the operation for enabling the trace-of-correction setting is received, the second display unit displays a screen indicating that a setting value of the setting related to the trace-of-correction setting is set to a setting value that enables the trace-of-correction setting.

17. The image processing apparatus according to claim 15, wherein, on the setting screen of the setting related to the trace-of-correction setting, a setting value that disables the trace-of-correction setting is displayed in an unselectable state.

18. The image processing apparatus according to claim 15, wherein the setting related to the trace-of-correction setting is at least one of a color setting, a file format setting, or a density setting.

19. A control method comprising:
generating original document data by reading an original document;
transmitting the original document data;
receiving an operation for providing an instruction to transmit the original document data;
receiving an operation for enabling a trace-of-correction setting being a setting for including, in the original document data, a trace of correction indicating that the original document has been corrected; and
displaying a predetermined screen in a case where the receiving receives transmission of the original document data, and the receiving receives an operation for enabling the trace-of-correction setting.

20. A control method comprising:
generating original document data by reading an original document;
transmitting the original document data;
receiving an operation for providing an instruction to transmit the original document data;
receiving an operation for enabling a trace-of-correction setting being a setting for including, in the original document data, a trace of correction indicating that the original document has been corrected; and
transmitting the original document data in a state where the trace-of-correction setting is disabled in a case where the receiving receives transmission of the original document data, and the receiving receives an operation for enabling the trace-of-correction setting.
